(19) United States
(12) Patent Application Publication
(10) Pub. No.: US 2001/0011026 A1
(43) Pub. Date: Aug. 2, 2001

(54) Transmitter-receiver unit capable of being charged without using dedicated charger

(75) Inventor: Akio Nishijima, Fukushima-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 09/755,248

(22) Filed: Jan. 3, 2001

(30) Foreign Application Priority Data
Jan. 28, 2000 (JP) 2000-019930

(51) Int. Cl. H04M 1/00

(52) U.S. Cl. 455/557; 455/573

(57) ABSTRACT

For performing communication by a mobile telephone and charging thereof without connecting the mobile telephone to different devices, an adapter is provided with a connector connected to a signal terminal of the mobile telephone for the transmission and reception of transmission data and reception data for the mobile telephone and charging connectors connected to a charging terminal of the mobile telephone for the supply of a charging electric terminal, the adapter being connected to a personal computer body through a predetermined interface. During communication, through the connector, transmission data is generated on the basis of data inputted from a keyboard and reception data is processed so as to be capable of being displayed on a display. While communication is not performed, through the charging connectors, electric power is supplied from a power supply section to charge the mobile telephone.

### BACKGROUND OF THE INVENTION

1. Field of the Invention

The present invention relates to a transmitter-receiver capable of making communication with use of a mobile telephone and more particularly to a transmitter-receiver unit which permits charging of a mobile telephone.

2. Description of the Prior Art

FIGS. 6 and 7 are schematic diagrams for explaining conventional transmitter-receiver units.

A transmitter-receiver unit 50 shown in FIG. 6 is made up of a desk-top type personal computer body 51, a display (display section) 52, a keyboard (input section) 53, and a modem 54.

Within the personal computer body 51 is provided a control section for making various controls. The control section makes controls to display data such as characters and images on the display 52 connected to the control section through a predetermined interface, on the basis of data inputted from the keyboard 53 which is connected to the control section through a predetermined interface. The modem 54 is connected to the personal computer body 51 through a cable 54a of a predetermined interface (say, RS-232C). The modem 54 is also connected to an outdoor telephone network through a cable 54b.

Further, a power supply section (not shown) is provided in the interior of the personal computer body 51. The power supply section takes out an alternating current of 100 V (volts) from an AC plug socket, then converts it into a direct current of 12 V or less, and supplies electric power of a predetermined voltage to each of various circuits formed within the personal computer body 51 and also to the keyboard 53.

Through such an environment as mentioned above there are performed connection to the Internet and transmission and reception of mails.

On the other hand, with rapid spread of mobile telephones such as portable telephones, there is a tendency to an increase in the number of persons who carry only mobile telephones. Using mobile telephones, such persons make connection to the Internet in addition to the usual service.

FIG. 7 shows a transmitter-receiver unit 60 using a mobile telephone 7.

In the transmitter-receiver unit 60, a notebook type personal computer body 61 is utilized for connection. The personal computer body 61 is provided with a liquid crystal display (display section) 62, a keyboard (input section) 63, and a slot 61a.

The slot 61a is a standardized slot conforming to the PCMCIA (Personal Computer Memory Card International Association) standard. A card 56 or the like for connection of various peripheral devices is connected to the slot 61a. The card 56 is for connection between the personal computer and the mobile telephone 7 and for further connection with a communication environment such as the Internet. In use, a predetermined cable 58 is connected to the card 56. For the transmission and reception of data using the mobile telephone 7, the cable 58 is connected through a connector to a signal terminal of the mobile telephone 7.

Further, with the recent spread of the Internet, there is a tendency to an increase in the number of opportunities of transmitting data of large capacities such as dynamic and still pictures. Along this tendency there has been offered a communication service called ISDN (Integrated Services Digital Network) permitting faster data transmission and reception than before for the transmitter-receiver unit 50 shown in FIG. 6. For utilizing the ISDN service it is necessary to use another device such as a DSU (Digital Signal Unit) or a TA (Terminal Adapter) instead of the modem 54. By so doing, in contrast with the communication mode in which digital data inputted from the keyboard and outputted through the personal computer body 51 is converted to an analog signal and transmitted to the exterior by means of the modem 54, the digital data is transmitted as a digital signal as it is to the exterior, thus permitting faster and stabler data transmission than before.

According to the conventional transmitter-receiver unit 50 shown in FIG. 6, however, for those having only mobile telephones it is necessary make a contract for utilizing a telephone line separate from the mobile telephones. This is troublesome.

Further, the transmitter-receiver unit 60 shown in FIG. 7 requires a troublesome operation for the insertion and extraction of the card 56 with respect to the slot 61a. In addition, during connection to the Internet, electric power remains consumed and thus it has so far been impossible to continue the connection for a long time. Therefore, in the event of power consumption of the mobile telephone, it has so far been required to connect the mobile telephone to a dedicated charger and conduct charging for a predetermined time.

With improvement of the communication speed using the mobile telephone 7, a communication environment equivalent to the foregoing ISDN is becoming common, and the development of a new mobile telephone capable of transmitting data at a higher speed is also expected. In addition, as the Internet tends to become spread more and more, an increase in the number of users who uses the mobile telephone 7 for connection to the Internet is expected.

### SUMMARY OF THE INVENTION

The present invention has been accomplished for solving the above-mentioned problems and it is an object of the invention to provide a transmitter-receiver unit capable of connecting to the exterior such as the Internet continuously for a long time with use of a mobile telephone for example and capable of charging without connection to a dedicated charger in the event of power shortage of the mobile telephone.

According to the present invention, for achieving the above-mentioned object, there is provided a transmitter-receiver unit comprising an input section, a display section, a control section which processes data inputted by the input section into a form capable of being displayed on the display section and produces transmission data on the basis of the inputted data and which processes received data into a form capable of being displayed on the display section, a power supply section for the supply of a predetermined electric power, a connector connected to a signal terminal of a mobile telephone for the transmission and reception of the transmission data and reception data for the mobile telephone, and a charging connector for the supply of a charging electric power to a charging terminal of the mobile telephone.

According to the transmitter-receiver unit of the present invention, it becomes possible to make connection to the exterior, say, the Internet, for a long time without consumption of the electric power of the mobile telephone even while the transmission and reception of transmission data and reception data are being conducted. Therefore, the fear of communication being blocked by battery exhaustion and the troublesomeness of making connection again after charging, even during communication, are eliminated. In addition, if the electric power accumulated within the mobile telephone in a disconnected state of the telephone, charging is conducted in the same way as in the use of a conventional dedicated charger.

Preferably, there is provided an adapter which has the connector and the charging connector, the adapter being connected to the control section through a predetermined interface.

For example, the adapter is connected to a personal computer body through a predetermined interface and predetermined application programs for communication and driver software are introduced, together with an operating system, into the personal computer body. As the aforesaid interface there may be used, for example, a USB (Universal Serial Bus) having a power line capable of supplying electric power for charging the mobile telephone.

With the USB, it is possible to easily effect the insertion and extraction of a cable for the computer body even when power is ON.

In the present invention it is optional whether the adapter is to be integral with the foregoing input section or with the foregoing display section.

As an example of the input section, mention may be made of a keyboard. By connecting a mobile telephone which the user carried when he or she was out to a predetermined position of the keyboard upon returning home, there is made an immediate connection to the Internet for example and it is possible to inspect a homepage or perform the transmission or reception of mail. In addition, while the state remains intact, it is possible to charge the mobile telephone. Further, by taking out the mobile telephone from the adapter it is possible to use the mobile telephone as the ordinary type of a telephone. Thus, both communication by the mobile telephone and charging of the mobile telephone can be done using a single adapter; that is, it is possible to attain the improvement of handleability.

As an example of the above display section, mention may be made of a display connected to the personal computer body.

The above adapter may be provided separately from the input section and the display section. For example, it may be provided in the personal computer body, a pointing device, or any other peripheral device.

### BRIEF DESCRIPTION OF THE DRAWINGS

FIG. 1 is a schematic diagram showing in what mode a transmitter-receiver unit according to an embodiment of the present invention is used;

FIG. 2 is a circuit block diagram of the transmitter-receiver unit;

FIG. 3 is a schematic diagram showing in what mode a transmitter-receiver unit according to another embodiment of the present invention is used;

FIG. 4 is a circuit block diagram of the transmitter-receiver unit;

FIG. 5 is a circuit block diagram of a transmitter-receiver unit according to a further embodiment of the present invention;

FIG. 6 is a schematic diagram showing a mode of use of a conventional transmitter-receiver unit; and

FIG. 7 is a schematic diagram showing a mode of use of another conventional transmitter-receiver unit.

### DETAILED DESCRIPTION OF THE PREFERRED EMBODIMENTS

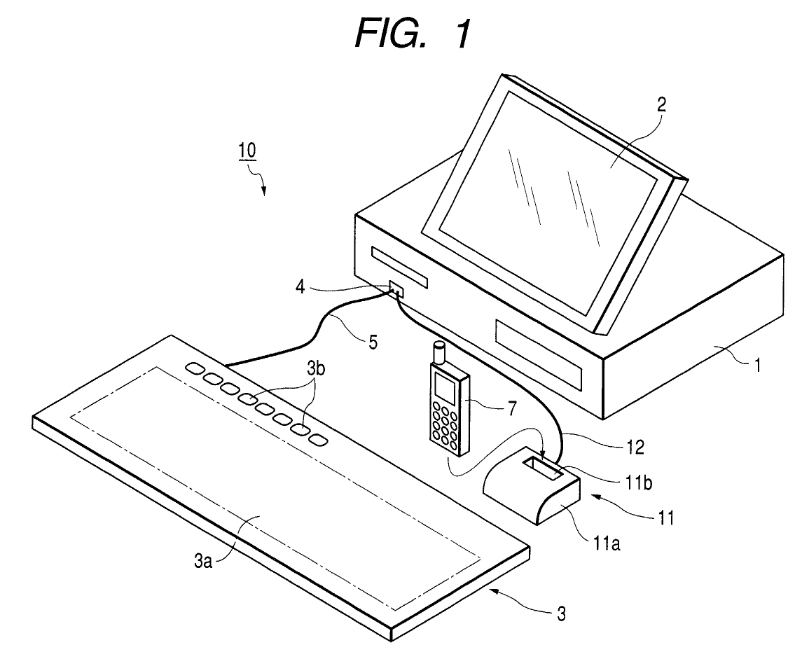

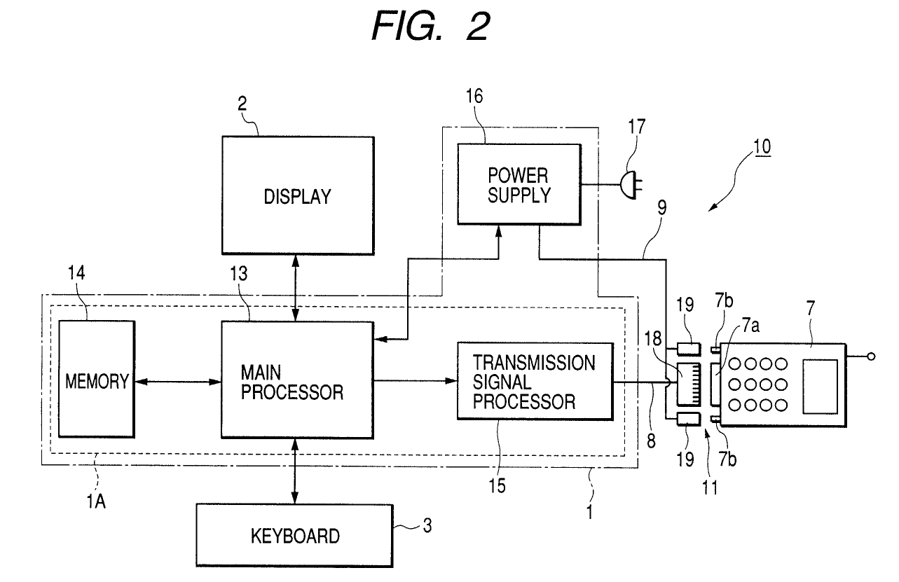

A transmitter-receiver unit according to an embodiment of the present invention will be described hereinunder with reference to FIGS. 1 and 2, of which FIG. 1 is a schematic perspective view of the transmitter-receiver unit and FIG. 2 is a circuit block diagram thereof.

The transmitter-receiver unit, shown in FIG. 1 and indicated at 10, is provided with a personal computer body 10, a display 2 as a display section, a keyboard 3 as an input section, and an adapter 11. The transmitter-receiver unit 10 may be further provided with a pointing device and any other peripheral device (neither shown).

In the personal computer body 1, the display 2, keyboard 3, and adapter 11 are connected together respectively through predetermined interfaces.

A plurality of keys 3a are arranged on an upper surface of the keyboard 3, which keyboard is connected through a USB interfacing cable to a USB port 4 formed in the personal computer body 1. The keyboard 3 may be connected to a PS/2 interface to the personal computer body 1. On the keyboard 3 there may be provided a plurality of buttons 3b to which various functions can be allocated. For example, starting operations of application programs for inspection of the Internet may be registered in the buttons 3b, or mail application starting operations, mail transmission and reception, and a series of operations until the end of application programs may be registered in the buttons 3b. Or other functions may be registered in the buttons.

The adapter 11, which is connected as a single component to the personal computer body 1, is made up of a housing 11a of a predetermined shape and a holder portion 11b in which is held a mobile telephone 7 such as a portable telephone. The adapter 11 is connected through a USB interfacing cable 12 to the USB port 4 formed in the personal computer body 1. Without using the housing 11a of the adapter 11, the cable 12 may be formed with a predetermined connector for direct connection to the mobile telephone 7.

In the personal computer body 1, as shown in FIG. 2, a control section 1A having a main processor 13, a memory 14, and a transmission signal processor 15, and a power supply section (power supply-circuit) 16 are provided.

The main processor 13 is constituted by a CPU (Central Processing Unit) or a predetermined microcomputer and performs predetermined processings in accordance with data inputted from keys 3a and buttons 3b on the keyboard 3.

In the memory 14, for example an application program for Internet connection or an application program for the transmission and reception of mail is read from a storage device (a hard disk) and is sent to the main processor 13.

In the transmission signal processor 15, digital data for communication outputted from the main processor 13 is converted to a digital or analog signal corresponding to the mobile telephone 7. The digital or analog signal is transmitted to the adapter 11 through the USB cable 12 (see FIG. 1).

The adapter 11 is provided with a connector 18 connected to a signal terminal 7a of the mobile telephone 7 and functioning to transmit and receive data with respect to the mobile telephone 7 and is further provided with a pair of charging connectors 19 connected respectively to charging terminals 7b of the mobile telephone 7 to supply a charging electric power. The connector 18 and the charging connectors 19 may be a general-purpose type so as to be applicable to various mobile telephones 7, or may be those corresponding to the type of the mobile telephone 7 used and the connectors 19 may be replaceable according to the telephone type used.

Through the USB interfacing cable 12 (see FIG. 1) the connector 18 and the connectors 19 are connected to the power supply section 16 disposed within the personal computer body 1.

In the power supply section 16 is provided an AC plug 17, which is connected to a plug socket (AC plug socket) formed indoors for example to supply an alternating current of, say, 100 V. The AC 100 V is converted to a direct current of 12 V or 5 V in the power supply section 16, which direct current is then fed to the main processor 13, memory 14, transmission signal processor 15, keyboard 3, and mobile telephone 7. The power supply section 16 need not always be provided within the personal computer body 1; it may be provided on the AC plug 17 side in the case of a notebook type computer.

The above USB interface is composed of a total of four lines which are a pair of signal lines 8 and a pair of power lines 9, the signal lines 8 being a D+ (D plus) line and a D− (D minus) line, respectively, for data transmission, and the power lines 9 being a power line (5 V) and a ground line, respectively. In this case, serial data flowing in the paired signals lines 8 is treated as differential signals.

The charging connectors 19 of the adapter 11 can be supplied with electric power of, say, 5 to 5.5 V, 500 mA which permits charging of the mobile telephone 7.

Once the mobile telephone 7 is set to the adapter 11 as in FIG. 1, it becomes possible to make connection to the exterior such as the Internet through the mobile telephone 7, using the connector 18 and the D+ and D− lines of the USB interfacing cable 12.

In the control section 1A, processing is performed so that digital data inputted through the keyboard 3 or a mouse (not shown) is displayed on the display 2, and transmission data (a digital or analog signal) is produced won the basis of the digital data and is transmitted from the mobile telephone 7. Also, processing is made therein so that data is displayed on the display 2 on the basis of reception data (a digital or analog signal) received by the mobile telephone 7. As the transmission data and reception data there may be used, for example, character data, image data, and program data.

During connection to the Internet through the mobile telephone 7, electric power can be supplied from the charging connectors 19. In this case, there may be conducted transmission and reception while charging a secondary battery which is disposed beforehand within the mobile telephone 7 and which can be charged. Alternatively, without charging the mobile telephone 7, the electric power fed from the power supply section 16 may be consumed directly in the mobile telephone 7.

In the case where there is made no connection to the Internet through the mobile telephone 7, the secondary battery disposed in the mobile telephone may be charged with the electric power fed from the charging connectors 19. That is, the electric power fed from the AC plug 17 is converted to a predetermined voltage in the power supply section 16, which voltage is fed to the charging connectors 19 through the cable 12 and passes the charging terminals 7b of the mobile telephone 7, whereby the secondary battery can be charged.

When the mobile telephone 7 is called or when it is carried outdoors by the user, the mobile telephone 7 can be taken out from the adapter 11 for conversation by the telephone.

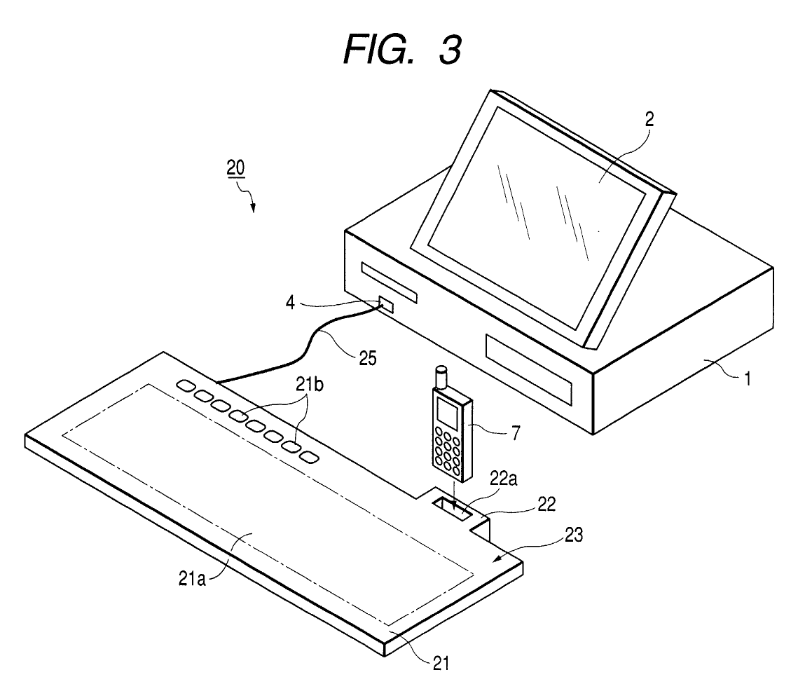

FIG. 3 illustrates a transmitter-receiver unit 20 according to another embodiment of the present invention. The transmitter-receiver unit 20 is provided with a keyboard device 23 wherein the above keyboard 3 and the adapter 11 are integral with each other. Other constructional points are the same as in the transmitter-receiver unit 10 described above and therefore explanations thereof will here be omitted.

In the keyboard device 23, a keyboard body 21 and an adapter 22 are integral with each other. On the keyboard body 21 are arranged a plurality of keys 21a and buttons 21b which permit registration of programs therein. Further, the adapter 22 is provided with a holder portion 22a to which the mobile telephone 7 can be connected.

The keyboard device 23 is connected the USB port 4 formed in the personal computer body 1 through a cable 25 which utilizes USB interface. With the USB interface, the keyboard body 21 and the adapter 22, which are plural different devices, can be connected through a single USB cable to the personal computer body and it is possible to supply a predetermined electric power to the adapter 22.

Thus, by mere placing and connection of the mobile telephone 7 to the adapter 22, it becomes possible to effect a continuous connection to the Internet environment through the mobile telephone 7. In addition, when not in connection, it is possible to charge the mobile telephone 7.

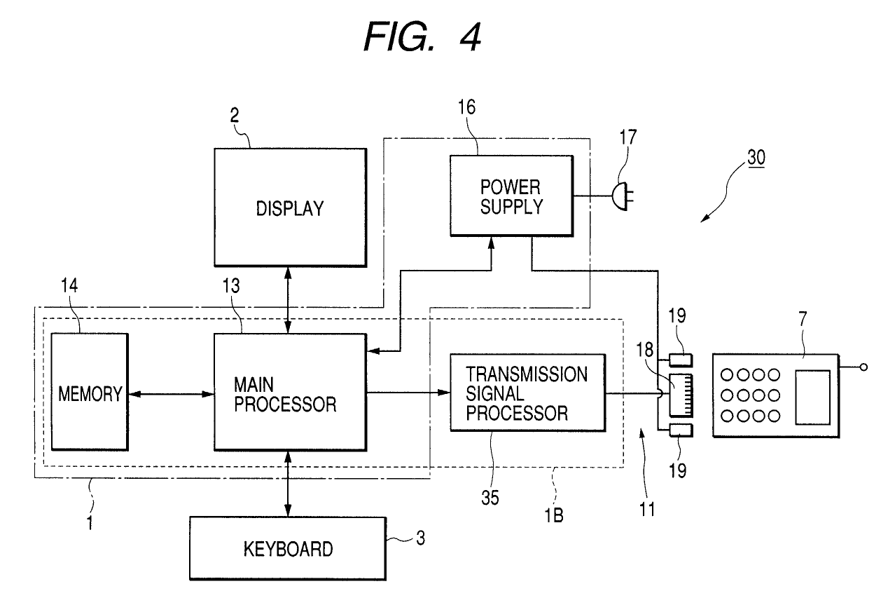

FIG. 4 is a block diagram illustrating a transmitter-receiver unit 30 according to a further embodiment of the present invention, in which a transmission signal processor 35 corresponding to the transmission signal processor 15 in the transmitter-receiver unit 10 shown in FIG. 2 is provided on the adapted 11 side, not within the personal computer body 1. In this embodiment, a control section 1B is composed of the main processor 13, memory 14, and transmission signal processor 35. Other constructional points are the same as in the transmitter-receiver unit 10 illustrated in FIG. 1 and so explanations thereof will here be omitted.

More specifically, in appearance, the transmitter-receiver unit 30 is of the same construction as the transmitter-receiver 10, with the transmission signal processor 35 being formed within the adapter 11. Like the foregoing, USB interface is utilized for the adapter 11 and connection is made through the cable 5 to the USB port 4 formed in the personal computer body 1.

Thus, even if the transmission signal processor 15 is not disposed in such a standard or extended form within the personal computer body 1 as in FIG. 2, a mere connection of the adapter 11 to the personal computer body permits utilization of the mobile telephone 7, thereby making it possible to enhance the versatility. Thus, both communication and charging can be done by merely placing the mobile telephone 7 in the adapter 11.

In the transmitter-receiver unit 20 shown in FIG. 3, the portion corresponding to the transmission signal processor 15 may be provided within the keyboard device 23.

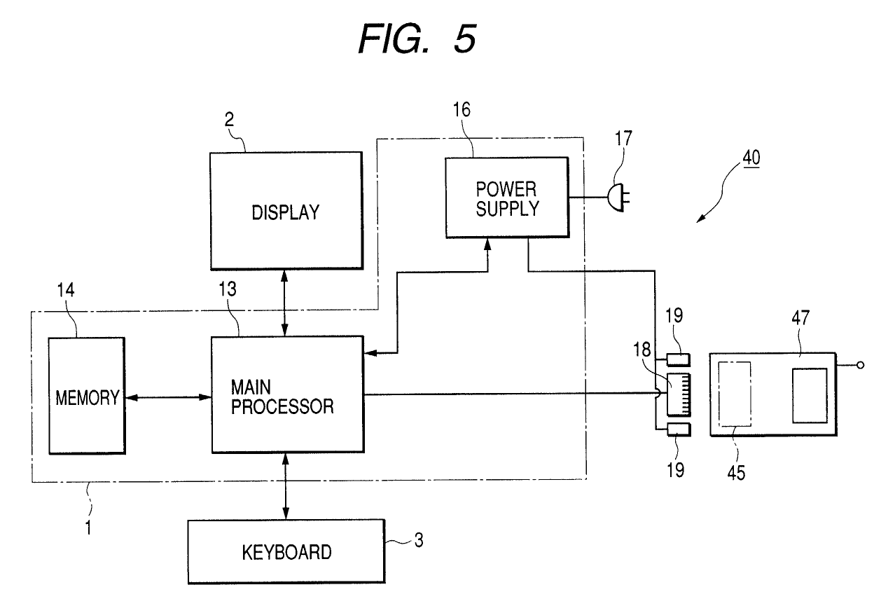

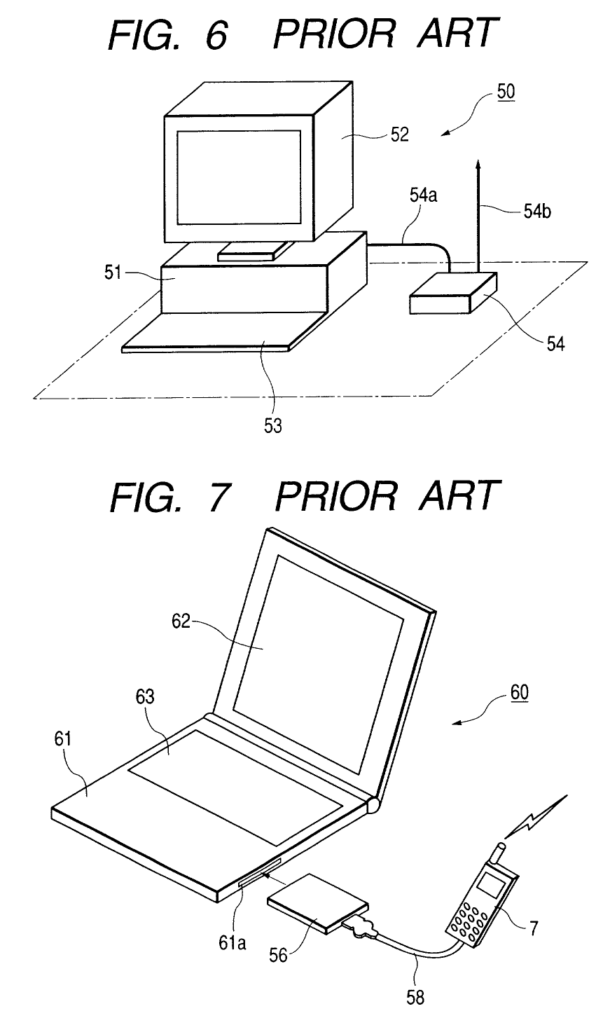

The present invention is not limited to the above embodiments. For example, the invention is applicable to such a transmitter-receiver unit 40 as shown in FIG. 5, in which a transmission signal processor 45 corresponding to the transmission signal processors 15 and 35 is provided beforehand within a mobile telephone 47. In this case, that is, even if the transmission signal processor is not provided within the personal computer body 1 or the adapter 11, it is possible to simplify the circuit configuration of the transmitter-receiver unit. In the transmitter-receiver unit 40, the main processor 13, memory 14, and power supply section 16 are provided within the personal computer body 1, and a control section corresponding to the controls sections 1A and 1B is constituted by the main processor 13, memory 14, and transmission signal processor 45.

In the transmitter-receiver unit according to the present invention, not only the adapter 11 alone is connected to the personal computer body 1 as shown in FIG. 1, or the adapter 22 is formed integrally with the keyboard 21 and is used as the keyboard device 23 as in FIG. 3, but also an adapter may be integral with the display 2 or may be provided on the personal computer body 1 side. Further, an adapter may be integral with a pointing device used in a fixed state such as a pad type or track ball type. Or in the case of a mouse type radio pointing device with divided receiving section and transmitting section, an adapter may be provided in the receiving section which is connected to the personal computer body 1 side.

The transmitter-receiver unit according to the present invention may be provided not only in a desk top or notebook type personal computer but also in a home television or in an automobile television or navigation system.

The interface used in the transmitter-receiver unit according to the present invention is not limited to the USB interface insofar as power supply lines are provided and electric power which permits charging of the mobile telephone can be supplied. There may be used an interface which permits data transfer at a higher speed than USB.

According to the present invention, as set forth above, both connection to the Internet through a mobile telephone and charging of the mobile telephone itself can be effected. As a result, a halfway disconnection due to battery exhaustion during connection is prevented and a continuous long-time connection can be implemented. In addition, it is not necessary to transfer the mobile telephone onto a dedicated charger provided separately and used exclusively for charging the mobile telephone. Thus, when the user is outdoors, he or she can carry the mobile telephone for conversation, while when the user returns home, both charging of the mobile telephone so far usually conducted and connection to the Internet can be done easily by only setting the mobile telephone to a predetermined position without transfer of the mobile telephone, thus permitting improvement of both handleability and operability.

What is claimed is:

1. A transmitter-receiver unit comprising:
an input section;
a display section;
a control section which processes data inputted by the input section into a form capable of being displayed on the display section and produces transmission data on the basis of the inputted data and which processes received data into a form capable of being displayed on the display section;
a power supply section for the supply of a predetermined electric power;
a connector connected to a signal terminal of a mobile telephone for the transmission and reception of the transmission data and the reception data for the mobile telephone; and
a charging connector for the supply of a charging electric power to a charging terminal of the mobile telephone.

2. A transmitter-receiver unit according to claim 1, further including an adapter which has both the connector and the charging connector, the adapter being connected to the control section through a predetermined interface.

3. A transmitter-receiver unit according to claim 2, wherein the adapter is integral with the input section.

4. A transmitter-receiver unit according to claim 2, wherein the adapter is integral with the display section.

5. A transmitter-receiver unit according to claim 2, wherein the adapter is provided separately from the input section and the display section.
